(19) United States
(12) Patent Application Publication
(10) Pub. No.: US 2009/0277971 A1
(43) Pub. Date: Nov. 12, 2009

(54) Economical, dripless, reciprocating atomizer

(75) Inventor: James Scott, Saint Augustine, FL (US)

Correspondence Address: James Scott, 712 Porta Rosa Circle, Saint Augustine, FL, 32092, US

(73) Assignee: James Scott, Saint Augustine, FL (US)

(21) Appl. No.: 12/152,071

(22) Filed: May 12, 2008

(51) Int. Cl. B05B 17/04

(52) U.S. Cl. 239/4; 239/102.2

(57) ABSTRACT

An economical, dripless, reciprocating atomizer comprised of a piezo bender (20), an atomizer assembly (25), a transport line (23), and a mount body (24). A driver circuit (29) provides the power to drive the piezo bender (20) at sonic and ultrasonic frequencies via a means of electrical connection (21). The vibration is transmitted through the transport line (23) to the atomizer assembly (25) comprised of an active plate (25A) and passive plate (25D) resonating in opposing directions. Pressurized liquid from a liquid supply (30) passes through the transport line (23) and arrives at the atomizing assembly (25) where reciprocating ultrasonic vibration atomizes the liquid. Details of the preferred embodiment as well as additional ramifications are provided and shown.

### CROSS-REFERENCE TO RELATED APPLICATIONS

Not applicable

### FEDERALLY SPONSORED RESEARCH

Not Applicable

### SEQUENCE LISTING OR PROGRAM

Not Applicable

### BACKGROUND

1. Field of Invention

This invention relates to ultrasonic atomization of low viscosity liquids including atomization of fuels for internal combustion engines.

2. Prior Art

Ultrasonic atomization is a well-known art and a description of an application of an ultrasonic device is found in a paper by J. N. Antonovich, entitled “Ultrasonic Atomization of Liquids” which appears in “Transactions of Ultrasonics” (February 1959, Pages 6-15) published by the United States Institute of Radio Engineers. Electromagnetic, magneto restrictive, and piezoelectric effects are known to produce ultrasonic vibrations.

The piezoelectric effect is achieved by applying a voltage to a material, which possesses a particular crystalline lattice (also called the piezo element or element). The electrons influence the element and cause its geometry to change. This change overall translates into contraction or expansion depending on the polarity of the voltage applied. A common material used to manufacture piezoelectric devices is Lead Zirconium Titanium (PZT), although many other materials are commercially available.

PZT is manufactured in many shapes and configurations depending on the application. A type of piezo actuator called a piezo bender is constructed of a thin, flexible substrate (often metallic) in which a thin layer of PZT is bonded. The PZT bonded to the substrate results in unimorphic, or bimorphic movement when electrified. Piezo benders are currently the most economical and commercially available piezoelectric actuators on the market.

An alternating electrical signal generator or driver circuit supplies an alternating voltage to the bender. During the positive cycle (or phase) of the signal the element expands causing the flexible metallic substrate to warp in a direction. As the voltage changes to the negative cycle, the element contracts and causes the substrate to warp in the opposite direction. A signal at 40.8 kHz repeats this warping action 40,800 times per second. The vibration at this rate is beyond the human range of hearing and is considered “ultrasonic”.

Liquid vibrating at ultrasonic frequencies form surface waves and a disruption in the surface tension of the liquid. Atomization of the liquid occurs when the proper amplitude of the ultrasonic vibration is achieved cresting the surface waves and breaking the surface tension, casting off minute droplets.

Piezoelectric materials have specifications disclosed by the manufacturer. The most important consideration is the operating temperature, as overheating will cause the piezo element crystalline lattice to disorientate and permanently lose any useable properties (known as the Curie temperature). To prevent the element from malfunctioning it is important to stay within the operating voltages and temperatures set forth by the manufacturer. Operating frequency, power consumption, and overall lattice distortion of the piezoelectric material are also considered when designing piezoelectric devices for liquid atomization.

Several issues arise concerning prior art, which are addressed by this invention. U.S. Pat. No. 3,860,173 issued Jan. 14, 1975 to Sata and U.S. Pat. No. 5,145,113 issued Sep. 8, 1992 to Burwell et al both employ liquid return capabilities to handle excess liquid (dripping) that has been improperly atomized. These devices rely on gravity to function properly and thus must be orientated accordingly. U.S. Pat. No. 4,799,622 issued Jan. 24, 1989 to Ishikawa et al utilizes an ultrasonic probe contacting the surface of the liquid supply channel, which is a source of frictional power loss and wear. U.S. Pat. No. 3,125,295 issued Mar. 17, 1964 to G. Moss et al requires a custom manufactured piezo element and offers no protection to the piezo element from direct heat related to combustion or open flame when used in combustion applications. U.S. Pat. No. 4,408,719 issued Oct. 11, 1983 to Last requires air flow as an addition function to perform the overall operation of atomization. U.S. Pat. No. 4,742,810 issued May 10, 1988 to Anders et al uses a powerful piezo element to drive multiple atomizing ports with no assurance each port will atomize at the same rate as other ports. U.S. Pat. No. 5,483,616 issued Jan. 9, 1996 to Chiu et al is subject to overheating, a problem common with ultrasonic atomizers. During operation, if the liquid is unavailable, the element will overheat in a matter of seconds and therefore requires a liquid level sensor to prevent this potential problem.

Cost is directly related to the power output, frequency response, density, material, and other factors used to manufacture piezo elements. Standard cylindrical and box shapes are more economical than custom shapes such as tubes and cones. Power is directly related to heat dissipation. The more electrical power a piezo element uses, the more heat must be dissipated in order to operate continuously.

### SUMMARY OF INVENTION

In accordance with the embodiments, a piezo bender supplies vibration to an atomizer assembly at 40.8 kHz. An electrical signal is supplied by a conventional signal generator or driver circuit and is connected to the piezo bender by a conventional electrical connection means. The liquid is supplied from a source to the atomizer assembly via a transport line. A mounting body provides a means to support the electrical connectors, liquid supply connection, transport line and piezo bender. Vibration is transmitted from the piezo bender to the atomizer assembly via the transport line extension.

During operation, liquid from the source is urged through the transport line and emerges at the atomizer assembly. The electrical signal causes the piezo bender to vibrate. The liquid is atomized by the vibrating atomizer assembly without dripping.

### DRAWINGS

### Figures

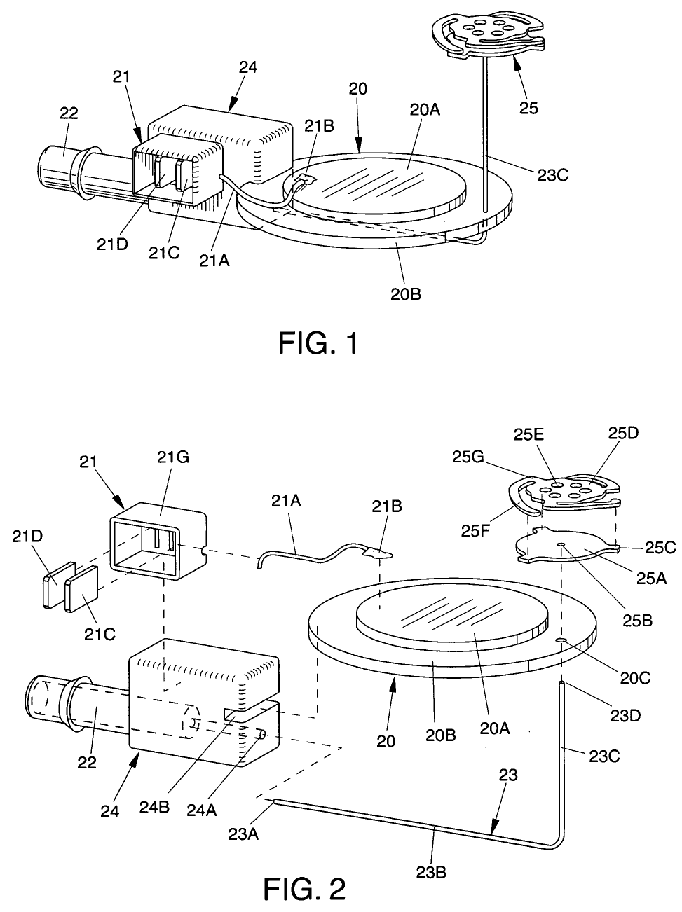

FIG. 1 shows a perspective view in accordance with preferred embodiment.

FIG. 2 shows a perspective exploded view in accordance with preferred embodiment.

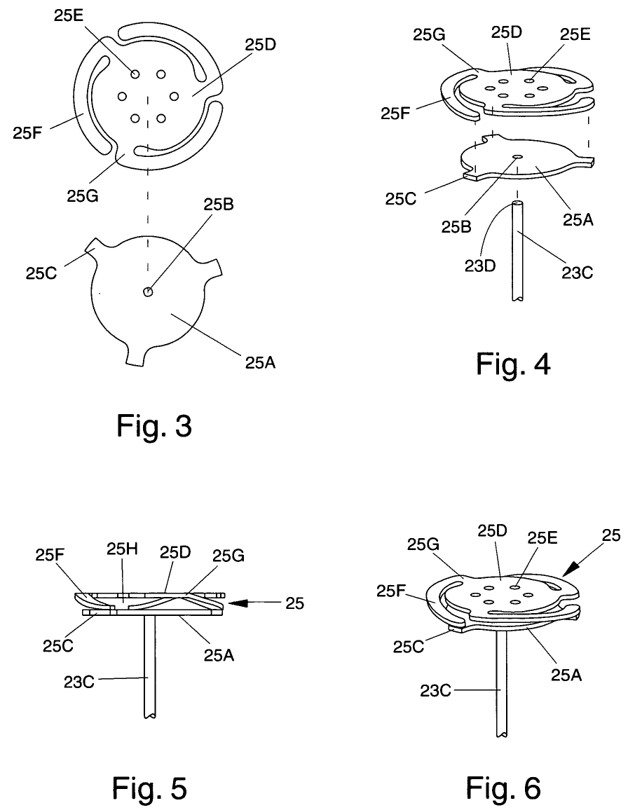

FIG. 3 shows a top exploded view of the atomizer assembly.

FIG. 4 shows a perspective exploded view of the atomizer assembly and partial view of the transport line extension aligned with the atomizer assembly.

FIG. 5 shows a side partial view of the atomizer assembly attached to the transport line extension.

FIG. 6 shows a perspective partial view of the atomizer assembly attached to the transport line extension.

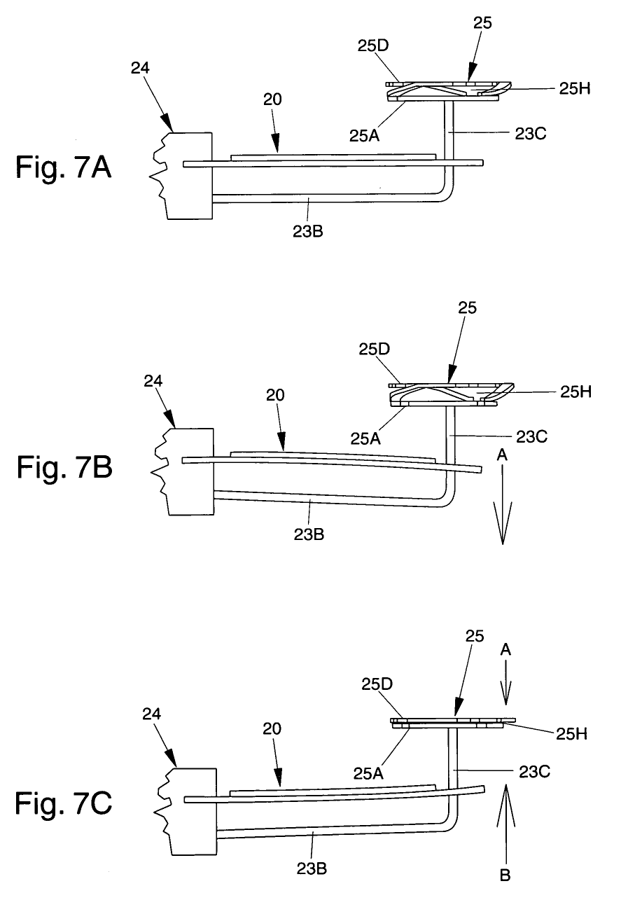

FIG. 7A shows a side partial view in accordance with preferred embodiment depicting the functional relationship between the piezo bender, transport line, and atomizer assembly at rest or zero voltage.

FIG. 7B shows a side partial view in accordance with preferred embodiment depicting the functional relationship between the piezo bender, transport line, and atomizer assembly at positive voltage phase of the operational cycle.

FIG. 7C shows a side partial view in accordance with preferred embodiment depicting the functional relationship between the piezo bender, transport line, and atomizer assembly at the negative voltage phase of the operational cycle.

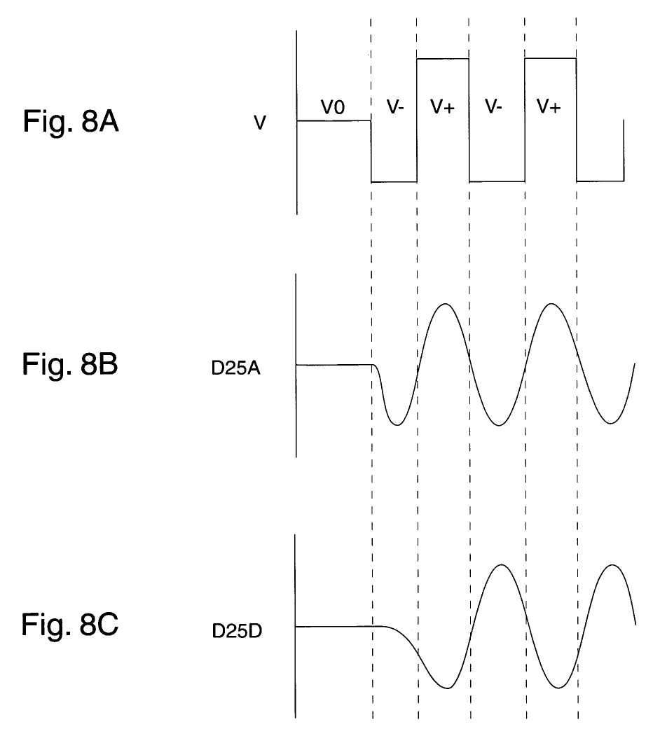

FIG. 8A is a graph depicting the voltage signal applied to the piezo bender.

FIG. 8B is a graph depicting the relative displacement of the active plate as it coincides with the voltage signal.

FIG. 8C is a graph depicting the relative displacement of the passive plate coincides with the voltage signal.

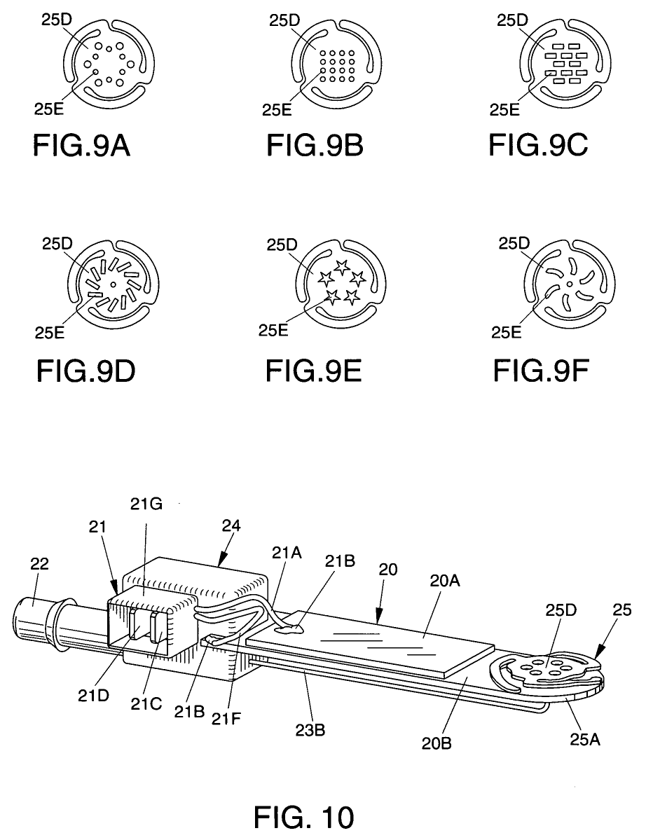

FIG. 9A to 9F are top view profiles of alternative passive plate design patterns for the atomizer assembly.

FIG. 10 is a perspective view in accordance with an alternative embodiment using a rectangular bender with integrated active plate, plastic mount support, additional conductive ground wire, and minimized transport line extension.

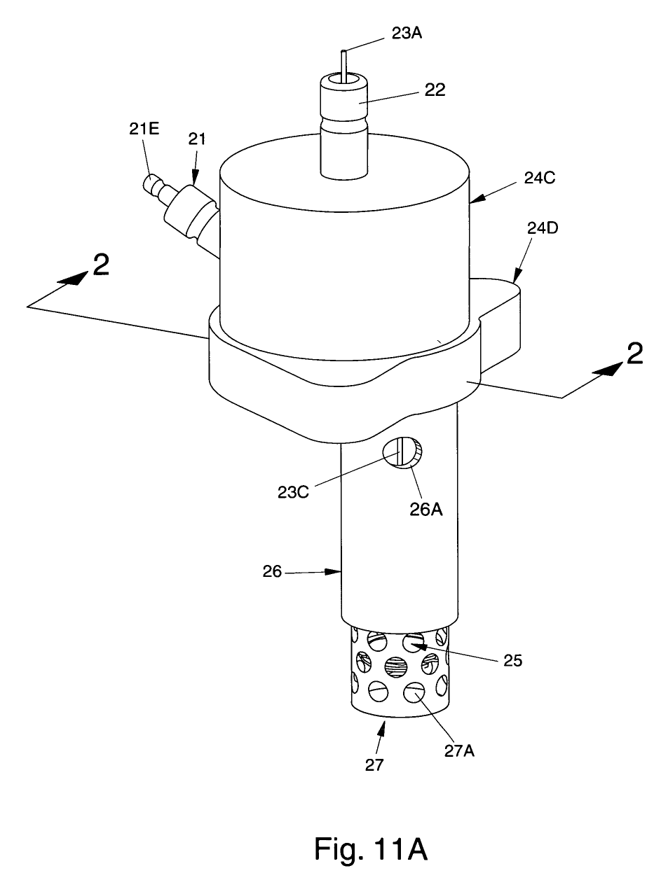

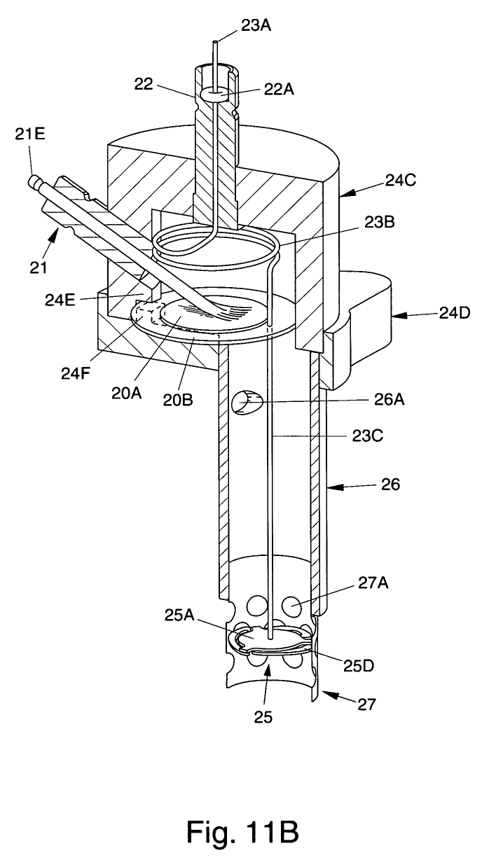

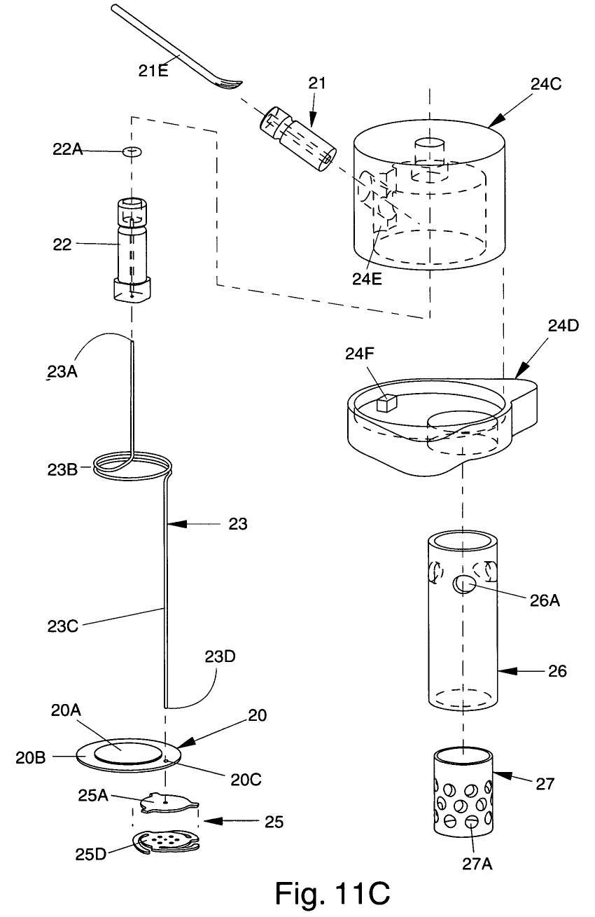

FIG. 11A is a perspective view of in accordance with a second alternative embodiment with an enclosed housing, swirler tube and flame guard.

FIG. 11B is a perspective cut-away view of FIG. 11A showing an internal adaptation of the piezo bender, transport line, atomizer assembly, mount support, electrical connection, and liquid connection.

FIG. 11C is a perspective exploded view of FIG. 11A showing relationship of parts.

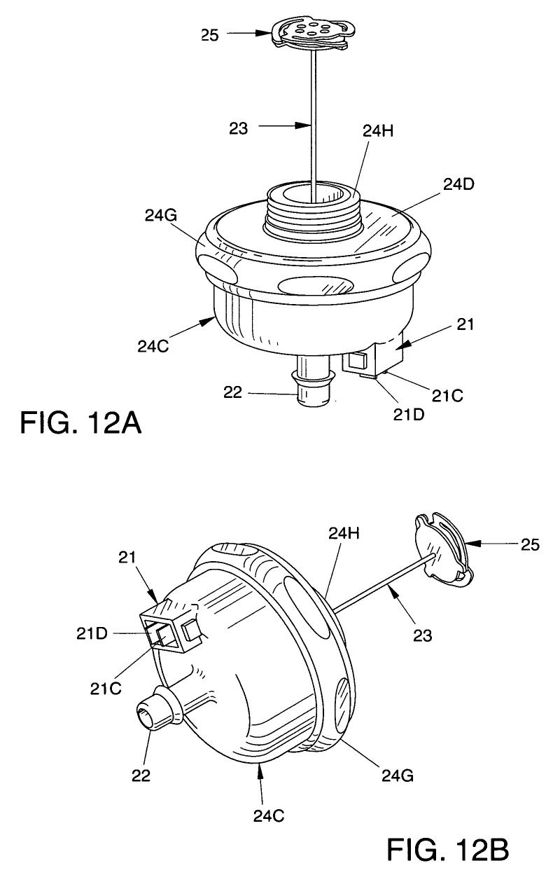

FIG. 12A shows a perspective view in accordance with a third alternative embodiment depicting a threaded enclosure housing made of plastic and a hexagonal clamping ring nut to show the versatility and potential production for off-the-shelf integration into other existing devices.

FIG. 12B is a perspective view of FIG. 12A from another angle to show the means of liquid and electrical connection.

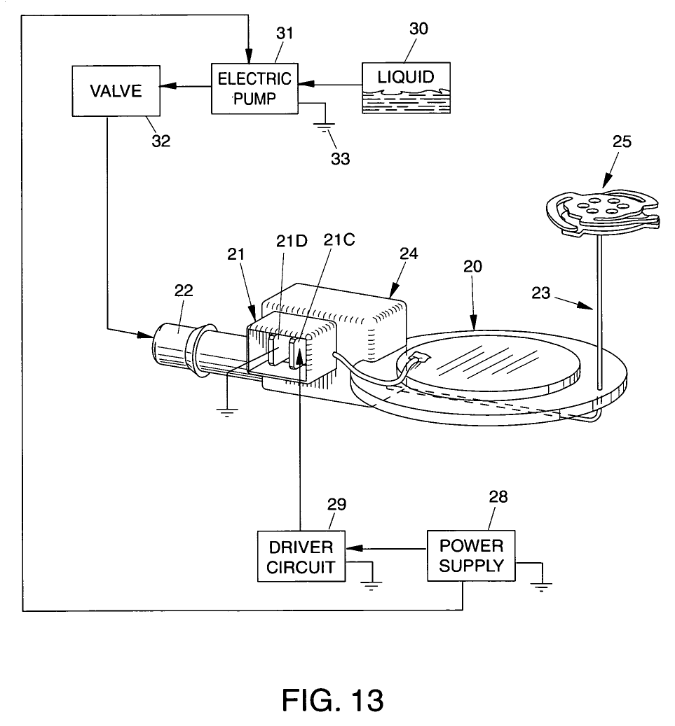

FIG. 13 is a block diagram depicting a typical operational work flow.

### REFERENCE NUMERALS

20 piezo bender
20A piezo element
20B piezo substrate
20C piezo orifice
21 means of electrical connection
21A conductive wire
21B conductive solder
21C conductive stave
21D conductive grounding stave
21E conductive brush
21F grounding wire
21G connector housing
22 liquid supply connector (means of liquid connection)
22A o-ring gasket
23 transport line
23A transport line inlet
23B transport line spring
23C transport line extension
23D transport line outlet
24 mounting body (means of mount support)
24A mounting body orifice
24B mounting body slot
24C mount housing
24D mount base
24E mount housing pinch block
24F mount base pinch block
24G hexagonal clamp ring nut
24H mount base threaded nipple
25 atomizing assembly
25A active plate
25B active plate orifice
25C active plate flange
25D passive plate
25E atomizing apertures
25F atomizing spring leaves
25G passive plate flange
25H gap between active plate and passive plate
D25A relative displacement of active plate from rest or 0 voltage
D25D relative displacement of passive plate from rest or 0 voltage
26 swirler tube
26A swirler tube orifice
27 flame guard
27A flame guard dilution holes
28 conventional power supply
29 conventional driver circuit
30 conventional liquid supply
31 conventional electric pump
32 conventional valve
33 ground
V voltage
V0 at rest or 0 voltage
V− negative voltage
V+ positive voltage
A downward direction
B upward direction

### DETAILED DESCRIPTION

### FIGS. 1, 2, 3, 4, 5, 6—Preferred Embodiment

Illustration FIG. 1 depicts the preferred embodiment suitable for atomization of low viscosity liquids including fuel for small internal combustion engines. The compact size and remote location of the atomizing assembly 25, makes this embodiment ideal for integration into devices of limited space requiring atomization where heat may affect the piezo element 20A.

The mount body 24 is constructed of brass providing a means of electrically conductive rigid support for the piezo bender 20 and transport line 23. The mount body 24 is rectangular, measuring 15 mm long, 8 mm wide, and 10 mm thick. Attachment of the piezo bender 20 is achieved by embedding the edge of the piezo bender substrate 20B 1.5 mm deep into a slot 24B in the longitudinal end of the mount body 24, 2.5 mm from the bottom of the mount body 24, aligned perpendicularly with the longitudinal axis of the piezo bender substrate 20B, and then bonding the adjoining surfaces with silver solder.

Grounding of the alternating electrical signal is achieved through the mount body 24 and conducted through the silver solder attachment to the conductive piezo bender substrate 20B. An additional electrical connection is made to the piezo element 20A by soldering 21B a conductive wire 21A to a nodal location on the surface of the piezo element 20A near the mount body 24.

The nodal location is determined by the operating frequency and the natural harmonic of the piezo bender 20. The piezo bender substrate 20B is made of brass 18 mm in diameter, 0.38 mm thick with a concentrically bonded layer of piezo electric material (the piezo element) 20A 13 mm in diameter and 0.25 mm thick with a natural resonant frequency of 6800 Hz as provided by manufacturer specifications.

The operating frequency is selected at 40.8 kHz, the 6^{th} harmonic of the natural resonant frequency of the piezo bender 20, therefore the closest nodal location to the mount body 24 is 3 mm from the attached edge of the piezo bender substrate 20B along its longitudinal axis. A 0.50 mm piezo bender substrate orifice 20C is drilled into the piezo bender substrate 20B, 15 mm from the mount body 24 along the piezo bender substrate 20B longitudinal axis, which is the furthest antinodal location existing on the piezo bender substrate 20B away from the mount body 24.

The transport line 23 is made of surgical hypodermic 304 stainless steel tubing with an outside diameter of 0.49 mm and inside diameter of 0.254 mm. 304 stainless steel has a Young's modulus approximately 195 Gpa and a density of 8.00 grams per cubic centimeters. The transport line 23 serves as two additional integrated functional components; the transport line spring 23B and the transport line extension 23C. The transport line 23 itself serves the purpose of transporting the liquid through its interior from the liquid supply connector 22 to the atomizing assembly 25.

The transport line inlet 23A is inserted 5 mm into a 0.50 mm diameter mount body orifice 24A, at a location 4.0 mm below and parallel with the longitudinal axis of the piezo bender 20, as shown in FIG. 2. The aforementioned mount body orifice 24A intersects with the interior of the liquid supply connector 22 and allows an urged liquid to travel from the liquid source into the transport line inlet 23A. The transport line inlet 23A exterior is silver soldered to the mounting body 24 and liquid supply connector 22 to provide a secure, leak proof attachment.

The transport line spring 23B provides vibrational dampening to the attachment where it meets the mount body orifice 24A. In preferred embodiment shown by FIGS. 1 and 2, the transport line spring 23B operates as a cantilever spring running parallel to the surface of the piezo bender substrate 20B along its longitudinal axis. The transport line spring 23B transitions into the transport line extension 23C, according to this embodiment, is denoted by the 90 degree bend in the transport line spring 23B, now perpendicular to the surface of the piezo bender 20.

The transport line extension 23C passes through the antinode piezo bender substrate orifice 20C and is attached to the piezo bender substrate 20B at this location with silver solder and extends perpendicularly 30 mm away from the piezo bender substrate 20B surface. The distance from the mount body 24 exterior where it intersects with the mount body orifice 24A, to the antinode piezo bender orifice 20C is 15 mm, giving the transport line spring 23B including the 90 degree bend the same length. The transport line extension 23C is perpendicular and concentrically aligned with the 0.50 mm active plate orifice 25B.

The transport line outlet 23D is inserted into the bottom of the active plate orifice 25B and extends until flush with the top of the active plate 25A. The transport line extension 23C is bonded to the active plate 25A by silver solder resulting in the transport line outlet 23D to communicate with the top surface of the active plate 25A.

As shown in FIGS. 3, 4, 5, and 6, the atomizer assembly 25 is comprised of the active plate 25A, active plate flanges 25C, passive plate 25D, passive plate flanges 25G, and atomizer spring leaves 25F, all using the same material, which is 304 stainless steel sheet 0.125 mm thick. The pattern of the active plate 25A and its integrated active plate flanges 25C, as well as the passive plate 25D and its integrated passive plate flanges 25G and atomizer spring leaves 25F, are produced using photochemical milling.

The passive plate 25D has six circular atomizing apertures 25E each 0.55 mm in diameter arranged symmetrically and radially, a distance of 1.5 mm around the axial center of the passive plate 25D. Both active plate 25A and passive plate 25D diameters are approximately 6.35 mm.

The atomizer spring leaves 25F are of a radial leaf type spring consisting of three identical leaves placed equidistantly around the periphery of the passive plate 25D. Each leaf is 0.75 mm wide and 7.5 mm long and spaced 0.75 mm away from the passive plate 25D with a shape contouring the passive plate 25D. The passive plate flanges 25G integrating the atomizing spring leaves 25F to the passive plate 25D protrude 1.5 mm away from the passive plate 25D, are parallel to the passive plate 25D, are symmetrically distributed radially around the axial center of the passive plate 25D, and are 0.75 mm wide with 0.2 mm fillets on the corners.

The active plate flange 25C configuration is the same as the passive plate flange 25G configuration, but rotationally offset allowing the terminating ends of the atomizing spring leaves 25F to rest on the active plate flanges 25C. Furthermore, the active plate 25A and passive plate 25D are concentrically aligned. The atomizing spring leaves 25F are equally bent downward from the integrated passive plate flanges 25G, which results in a parallel 0.2 mm atomizer gap 25H between the top surface of the active plate 25A and the bottom surface of the passive plate 25D as shown in FIG. 5. The terminating ends of the atomizer spring leaves 25F are attached to their aligned counterpart active plate flanges 25C by high frequency pinch welding.

As shown in FIG. 2, the liquid supply connector 22 is a brass barbed type approximately 5 mm outside diameter with a 3 mm inside diameter and an overall length of 30 mm. The mount body 24 has a 5 mm diameter hole aligned and intersecting with the mount body orifice 24A and the transport line inlet 23A. The liquid supply connector 22 is inserted into the mount body 24 hole 10 mm, and is attached by tin solder providing a leak proof connection, thereby allowing the interior of the liquid supply connector 22 to communicate with the interior of the transport line inlet 23A.

FIGS. 1 and 2 show a conventional means of electrical connection 21 made of rectangular plastic connector housing 21G with brass conductive male staves 21C and 21D, which are accessible by an open side of the connector housing 21G. The connector housing 21G is bonded to the mount body 24 with high strength epoxy. One end of a brass stave 21C is embedded in the connector housing 21G and soldered to a 32 gauge copper insulated conductive wire 21A. The opposite end of the 32 gauge copper insulated conductive wire 21A is soldered 21B to a nodal location on the piezo bender element 20A. The other brass stave 21D is soldered to the mount body 24 to provide a grounding connection to the conventional driver circuit 29.

### OPERATION

### FIGS. 2, 5, 7A, 7B, 7C, 8A, 8B, 8C, 13

A typical mode of operation illustrated by FIG. 13, the liquid supply 30 is connected to a conventional electric pump 31 and conventional valve 32 to control the liquid flow rate. The conventional valve 32 is connected to the liquid connector 22 of the embodiment whereby allowing the liquid to flow through the transport line 23 and emerge at the atomizer assembly 25. A conventional power supply 28 provides electrical power to drive the conventional electric pump 31 and conventional driver circuit 29. The conventional driver circuit creates an alternating voltage signal which is connected to means of electrical connection 21 which conducts the electrical signal to the piezo bender 20.

Liquid from a liquid supply 30 (FIG. 13) is urged through the liquid connector 22, which enters the transport line inlet 23A (FIG. 2). The liquid then travels through the transport line spring 23B and continues to flow through the transport line extension 23C.

The liquid exits the transport line outlet 23D emerging at the top surface of the active plate 25A where it floods the atomizer gap 25H (FIG. 5) between the active plate 25A and passive plate 25D.

The piezo bender 20 (FIG. 13) receives a 60 volt, 40.8 kHz alternating electrical signal from a conventional driver circuit 29 through the conventional means of electrical connection 21. Electrons flow through the piezo element 20A (FIG. 2) to the piezo bender substrate 20B, which is electrically grounded via the mount body 24 (FIG. 13).

In FIG. 7B, the piezo bender 20 rapidly warps and pulls the transport line extension 23C longitudinally downward in direction A, while flexing the transport line spring 23B. Simultaneously, the active plate 25A, which is attached to the transport line extension 23C, is pulled at the same rate and in direction A. The passive plate 25D, due to inertial delay resulting from the atomizer spring leaves 25F, remains stationary momentarily and then moves in direction A. At this phase of the electrical signal, the atomizer gap 25H between the active plate 25A and passive plate 25D is at a maximum.

FIG. 7C shows when the polarity of the electrical signal reverses. The piezo bender 20 warps in the opposite direction B and quickly pushes the transport line extension 23C longitudinally upward while recovering kinetic energy stored in the transport line spring 23B. Simultaneously, the active plate 25A is pushed at the same rate in direction B. However, the passive plate 25D is still moving in the original direction A due to momentum not yet overcome by the atomizer spring leaves 25F. At this phase, the atomizer gap 25H between the active plate 25A and passive plate 25D is at a minimum. The electrical signal changes polarity again and the direction of the active plate 25A is reversed. Kinetic energy stored in the atomizer spring leaves 25F is released causing the passive plate 25D to reverse its direction again where it reaches its maximum displacement relative to the active plate 25A.

The aforementioned action is repeated 40,800 times per second causing the liquid present in the atomizing gap 25H to atomize and eject through the atomizing apertures 25E in the passive plate 25D and the periphery of the atomizing gap 25H between the active plate 25A and passive plate 25D.

FIG. 8A shows a graph of the alternating voltage signal where V0 is at rest or zero voltage, V− being the negative voltage phase, and V+ being the positive voltage phase. FIG. 8B shows a coinciding graph of the displacement of the active plate D25A as it relates to the voltage phases of FIG. 8A. FIG. 8C shows the displacement of the passive plate D25D due to the delay caused by the atomizing spring leaves 25F.

Secondary atomization occurs on the top surface of the passive plate 25D where liquid, which has migrated from the atomizing gap 25H through the atomizing apertures 25E, receives vibration from the passive plate 25D.

The opposing movement of the active plate 25A and passive plate 25D allows for atomization to occur more efficiently and therefore with less power compared to other piezoelectric atomizers currently available.

The atomizer gap 25H between the active plate 25A and passive plate 25D being of close proximity, provides adequate surface area for the liquid to cling to, due to surface tension while the atomization occurs.

Liquid being supplied to the atomizing assembly at or below the rate of atomization produces a dripless result in any orientation.

Reciprocating motion of the active plate 25A and passive plate 25D is not the only vibrational force acting upon the liquid. The active plate 25A and passive plate 25D exhibit surface transversal vibrations in the form of standing waves, which additionally assist in the atomization process.

### FIG. 10—Alternative Embodiments

An alternative embodiment as shown in FIG. 10 depicts a structural design variation that utilizes all the features and operation as previously described by the preferred embodiment. FIG. 10 shows the elimination of the transport line extension 23C and active plate 25A, as the rectangular piezo bender substrate 20B serves as the active plate thereby reducing the overall profile of the atomizing apparatus. The mount body 24 is made of rigid plastic and integrated with the electrical connector housing 21G, thereby requiring an additional conductive grounding wire 21F soldered to the brass stave 21D and the piezo bender substrate 20B. This would be ideal for applications requiring compact, lightweight implementation of the atomizing apparatus where heat is not an adversity.

### FIGS. 11A, 11B, 11C—Alternative Embodiments

A second alternative embodiment illustrated by FIGS. 11A, 11B, and 11C show an aluminum enclosed means of mount support 24, whereby the mount body housing base 24D and mount body housing 24C provide an integrated upper pinch block 24E and lower pinch block 24F to clamp the end of the piezo bender substrate 20B when the two parts are attached. It utilizes a carbon fiber conductive brush 21E to deliver the electrical signal to the piezo element 20A. It has a swirler support tube 26 with a perforated flame guard 27 surrounding the transport line extension 23C and atomizer assembly 25. It uses a quick-snap liquid supply connector 22 as a means for liquid connection with an o-ring gasket 22A, as well as a helical transport line spring 23B for longitudinal operation. It functions the same as the preferred embodiment, however this was designed specifically to operate as a fuel atomizer for a small turbojet engine where high volume airflow and high temperature of the combustion chamber are a consideration.

### FIGS. 12A, 12B—Alternative Embodiments

A third alternative embodiment illustrated by FIGS. 12A and 12B show the mount housing 24C as a plastic sealed enclosure with a standard threaded nipple 24H and a metallic hexagonal clamping ring nut 24G for standard installation into an engine intake manifold or furnace combustion chamber. Internally the embodiment illustrated in FIGS. 12A and 12B is identical to the second alternative embodiment illustrated by FIGS. 11A, 11B, and 11C.

### FIGS. 9A-9F—Alternative Embodiments

Alternative atomizer assembly embodiments exploring the shape, size, construction, and materials of the active plate 25A and the passive plate 25D provide a variety of atomizing results in regards to operating frequency, droplet size, flow capacity, spray pattern, temperature threshold, lifespan, and economy. FIGS. 9A, 9B, 9C, 9D, 9E, and 9F illustrate example patterns of passive plates that have produced desirable results and it is thereby reasoned variations of other suitable patterns would provide atomization.

### ADVANTAGES

The objective of these embodiments is to overcome problems previously presented by the prior art. The embodiments produce ultrasonic atomization of low viscosity liquids, at a rate of 0.45 liters per hour, utilizing 6 watts of power at 40.8 kHz frequency.

The embodiments described achieve atomization using economical piezo benders that operate continuously well below the Curie temperature. Operation does not rely on gravity, and can have any orientation. It operates with a wide frequency response, eliminating the need for precision electrical signal control. Atomization occurs a distance away from the heat sensitive piezo bender element, allowing atomization to occur directly in an open flame or heat source. Other advantages of the embodiments are listed as follows:

(a) The mounting support can be made of lightweight, economical materials such as plastic or ceramic.

(b) The overall size of the embodiments can be made very compact and easily integrated into other devices.

(c) The utilization of inexpensive off-the-shelf piezo benders allows for rapid manufacturing.

(d) The liquid is atomized with low wattage consumption.

(e) The piezo bender provides low heat dissipation for continuous operation even when running dry. It won't overheat.

(f) The +/−5% bandwidth response allows for use of inexpensive low tolerance driver circuits.

(g) The dripless atomizer assembly is operational in any orientation. There is no need for an overflow or liquid return reservoir.

(h) The atomizer assembly can be made of high temperature, corrosion resistant materials and extended directly into a heat source without exposing the piezo element to heat or liquids.

(i) There is no frictional contact of parts resulting in low wear and long life of the components.

(j) It operates with low liquid supply pressure.

(k) Changes to the passive plate aperture design can provide a variety of spray patterns and droplet sizes.

(l) The reciprocal vibrating action of the atomizer assembly provides an efficient atomization of liquids.

(m) It operates at multiples of harmonics of the piezo benders natural frequency allowing for more versatile atomizing results.

### CONCLUSION, RAMIFICATIONS, AND SCOPE

The embodiments illustrate the use and operation for applications requiring liquid atomization. However, with minor ramifications to the embodiments, the applications of use include but are not limited to, fragrance dispensers, agricultural pesticide sprayers, semiconductor spin coating, textile pigmentation, and medical disinfectants. Since the cost of production, power consumption, and weight is significantly lower than piezoelectric atomizers currently commercially available, and in conjunction with its dripless atomizer assembly features, these embodiments would be beneficial to markets that require atomization of liquids on a consumable or disposable basis.

Although the description above provides many specifications, these should not be construed as limiting the scope of the embodiments but as merely providing illustrations of some of the presently preferred embodiments. For example, the means of mount support could be made of rigid non conductive plastic thereby requiring an alternative means of conducting the electrical signal to the piezo transducer. Soldered wires, spring brushes, or metallic plates could very easily be incorporated to provide electrical connection to the signal generator. As mentioned, the transport line spring and radial leaf springs of the plate head can be configured in any shape, which provides resonance from a variety of materials. Thus the scope of the embodiments should be determined by the appended claims and their legal equivalent, rather than by the examples given.

I claim,

1. An improved apparatus providing dripless reciprocating atomization of a liquid comprised of:
(a) a piezo bender, whereby providing a means of vibration operating at a frequency between 2 kHz to 2 MHz;
(b) a capillary transport line made of flexible resilient material comprising of an transport line inlet, transport line outlet, transport line spring, and transport line extension;
(c) an atomizing assembly comprised of an active plate, a passive plate, and an atomizing spring;
(d) a means providing electrical connection from an alternating electrical signal source to the piezo bender;
(e) a means providing liquid connection from a liquid source to the transport line inlet; and
(f) a means providing rigid mount support to securely attach the piezo bender, the transport line, the means of liquid connection, and the means of electrical connection.

2. The apparatus according to claim 1, wherein the piezo bender is comprised of:
(a) a thin, flat, tensile substrate with a layer of piezoelectric laminate bonded to the surface of the substrate;
(b) a symmetrical shape selected from a group of disc, square, triangular, rectangular and polygon;
(c) a type selected from a group consisting of unimorph and bimorph;
(d) being securely 1^{st} attached along one end to the mount supporting means, perpendicular to the longitudinal axis of the piezo bender;
whereby allowing the piezo bender to operate as a bending cantilever and providing reciprocating displacement perpendicular to the piezo bender substrate surface along its longitudinal axis;
(e) a substrate that has an orifice with a diameter equal to the outside diameter of the transport line passing perpendicularly through the substrate surface along the longitudinal axis near the end of the piezo bender opposite the 1^{st} attachment; and
(f) a means of electrical connection conducting an alternating electrical signal from a conventional driver circuit.

3. The apparatus according to claim 1, the transport line is comprised of:
(a) a uniform tubular capillary material with a Young's modulus greater than 100 gigapascals;
(b) the transport line inlet which is inserted into the liquid connector interior and sealed, whereby the interior of the liquid connector communicates with the interior or the transport line inlet;
(c) the transport line inlet and extends to integrally form the transport line spring; and
(d) the transport line spring which continues and integrates into the transport line extension and terminates at the transport line outlet.

4. The apparatus according to claim 3, the transport line spring is comprised of:
(a) a type selected from a group consisting of cantilever, torsional or helical; and
(b) a 2^{nd} attachment to the mount body and orientated in accordance with its movement as it relates to the movement of the piezo benders reciprocating displacement and direction.

5. The apparatus according to claim 3, wherein the transport line extension is comprised of:
(a) a linear geometry, passing through the orifice in the piezo bender where it is then 3^{rd} attached;
(b) a perpendicular alignment to the substrate surface of the piezo bender that extends a distance less than 12 centimeters, whereby the reciprocating displacement of the piezo bender is communicated through the longitudinal axis of the transport line extension during operation;
(c) an upwardly perpendicular projection into the lower surface of the active plate where it emerges flush with the upper surface of the active plate and is 4^{th} attached;
(d) the interior of the transport line outlet which communicates with the upper surface of the active plate; and
(e) the structural capability to transmit reciprocating displacement in the direction of its longitudinal axis from the piezo bender to the active plate during operation.

6. The apparatus according to claim 1, wherein the atomizing assembly is comprised of:
(a) a flat thin material with a Young's modulus of greater than 100 gigapascals;
(b) the active plate and the passive plate aligned concentrically and parallel to each other as well as the piezo bender substrate surface;
(c) the active plate being orientated above the piezo bender and below the passive plate;
(d) the active plate and passive plate which are connected by the atomizer spring and spaced a close distance from each other resulting in a thin gap between them when at rest;
(e) the active plate and passive plate which are comprised of similar radially symmetric shapes that include a plurality of integrally protruding flanges equal to the number of atomizing spring leaves, spaced equidistant along their periphery extending a distance from the axial center to accommodate the atomizing spring leaves;
(f) the active plate with an orifice through its axial center, a diameter equal to the outer diameter of the transport line extension, in which the transport line is inserted and 4^{th} attached; and
(g) the passive plate which has a plurality of apertures distributed symmetrically and concentrically about the surface with a combined void surface area less than 90% of the passive plate surface area.

7. The apparatus according to claim 6, wherein the atomizing spring is comprised of:
(a) a leaf type spring with a plurality of identical leaves spaced equidistant around the periphery of the passive plate;
(b) atomizer spring leaves of a length less than the number of leaves divided by the circumference of the passive plate, and are further comprised of a beginning and terminating end;
(c) the atomizing spring leaves concentrically contouring the geometry of the passive plate; and
(d) the beginning of each the atomizing spring leaves integrally projected from its accommodating passive plate flange to its terminating end at a slope and direction to engage the active plate flange where they are 5^{th} attached.

8. A dripless liquid atomizing method is comprised of:
(a) transporting vibration from an oscillating piezo bender and liquid by a capillary structural means to a thin active plate;
(b) attaching a thin perforated passive plate concentrically and parallel to the active plate by a spring resulting in a small clearance gap between the active plate and passive plate;
(c) delaying vibrations passing from the active plate through the spring to the passive plate allowing the passive plate to vibrate 90 degrees out of phase with the active plate, thereby amplifying reciprocating displacement between the active plate and the passive plate;
(d) suspending the liquid present in the small clearance gap between the active plate and passive plate due to the liquid surface tension preventing the liquid from dripping;
(e) atomizing liquid in the small clearance gap between the vibrating active plate and passive plate, which is ejected from the passive plate apertures and the periphery of the gap between the active plate and passive plate; and
(f) oscillating the active plate and passive plate at a frequency ranging from 2 kHz to 2 MHz.

9. An apparatus for atomizing liquid utilizing a piezo bender as a source of mechanical vibration comprised of a unimorphing or bimorphing piezo bender operating as a bending cantilever; wherein the piezo bender is attached at one end along its longitudinal axis to a means of rigid mount support, the other end attached to an atomizer assembly comprised of concentrically aligned vibrating plates in close proximity connected by a spring, whereby urged liquid arrives between the vibrating plates by a means of liquid transport and is atomized.
